(19) United States
(12) Patent Application Publication
(10) Pub. No.: US 2013/0182615 A1
(43) Pub. Date: Jul. 18, 2013

(54) ENERGY-SAVING MANAGEMENT METHOD AND SYSTEM FOR WIRELESS SENSOR NETWORK, AND REMOTE MANAGEMENT SERVER

(71) Applicants: Aifang Sun, Shenzhen (CN); Zhihao Ling, Shenzhen (CN); Yifeng Yuan, Shenzhen (CN); Chong Gao, Shenzhen (CN); Wenjun Yu, Shenzhen (CN)

(72) Inventors: Aifang Sun, Shenzhen (CN); Zhihao Ling, Shenzhen (CN); Yifeng Yuan, Shenzhen (CN); Chong Gao, Shenzhen (CN); Wenjun Yu, Shenzhen (CN)

(21) Appl. No.: 13/825,370

(22) PCT Filed: Jun. 29, 2011
(86) PCT No.: PCT/CN2011/076572

§ 371 Date: Mar. 21, 2013

(30) Foreign Application Priority Data
Sep. 21, 2010 (CN) 201010291640.4

(51) Int. Cl. H04W 52/02

(52) U.S. Cl. CPC H04W 52/0219
USPC 370/255; 370/311

(57) ABSTRACT

The disclosure provides an energy-saving management method and system for a wireless sensor network, and a remote management server. In the method, the wireless sensor network sends remaining energy information of a node, and/or network topology information, and/or node hibernation information to a remote management server through a gateway device; the remote management server stores the information, makes an energy-saving decision according to the information, and sends the energy-saving decision to the wireless sensor network through the gateway device; and the wireless sensor network makes a response according to the energy-saving decision. Through the solutions, the remote management server provides the wireless sensor network with an energy-saving strategy so as to reduce the processing amount of the wireless sensor network caused by network topology management, thereby reducing the power consumption, prolonging the lifetime, and implementing the remote energy-saving management of the wireless sensor network.

### TECHNICAL FIELD

The disclosure relates to an energy-saving technology for a wireless sensor network, in particular to an energy-saving management method and system for a wireless sensor network, and a remote management server.

### BACKGROUND

In a wireless sensor network, a wireless sensor node is often powered by a battery, which has an extremely limited power supply capacity and causes inconvenience when frequently charged or replaced. Therefore, how to reduce power consumption of a node and prolong lifetime of the wireless sensor network is worth studying.

At present, there are mainly two kinds of methods and technologies for studying energy saving of the wireless sensor network according to different study objects: an energy-saving technology for a single node and that for the whole wireless sensor network. The energy-saving technology for the single node mainly comprises: lower power consumption optimization for a hardware circuit and a software operating system of the node, energy-saving design for a wireless radio frequency transceiver, hibernation and wakeup mechanism, and the like. The energy-saving technology for the whole wireless sensor network mainly comprises: routing protocol based on energy efficiency, network topology management and control, data fusion processing and the like.

A characteristic of a conventional method is that certain energy-saving processing is performed only by the wireless sensor network itself. Whereas in the application background of an Internet of Things, the wireless sensor network can be coupled with a remote management server by a gateway and a remote communication network, therefore, how to utilize the remote management server to provide the wireless sensor network with an energy-saving management service is worth studying.

### SUMMARY

In view of the above, the disclosure provides an energy-saving management method and system for a wireless sensor network, and a remote management server, in order to utilize the remote management server to provide the wireless sensor network with an energy-saving management service.

The technical solution of the disclosure is implemented as follows.

The disclosure provides an energy-saving management method for a wireless sensor network, which comprises:

the wireless sensor network sending remaining energy information of a node, and/or network topology information, and/or node hibernation information to a remote management server through a gateway device;

the remote management server storing the remaining energy information of the node, and/or the network topology information, and/or the node hibernation information, making an energy-saving decision according to the remaining energy information of the node, and/or the network topology information, and/or the node hibernation information which are stored, and sending the energy-saving decision to the wireless sensor network through the gateway device; and

the wireless sensor network making a response according to the energy-saving decision of the remote management server.

In the solution, the wireless sensor network sending the remaining energy information of the node to the remote management server through the gateway device is: sending the remaining energy information of the node together with sensing data to the remote management server.

In the solution, an information storage format of the remote management server comprises: a network identifier, a node identifier, information of a routing from the node to the gateway device, the remaining energy information of the node, and the node hibernation information, wherein the remaining energy information of the node comprises an absolute value of remaining energy and percentage of the remaining energy.

In the solution, the energy-saving decision of the remote management server comprises: control for network topology, and control for hibernation and wakeup of the node, specifically: in the control for the network topology, the remote management server determining a type of the wireless sensor network according to the network topology information that is stored, and replacing, according to an energy balance rule, a routing node or a cluster head node at regular intervals or each time when certain energy is consumed; and in the control for the hibernation and wakeup of the node, the remote management server judging whether the node supports hibernation according to the node hibernation information, and sending a hibernation configuration command to node when the node supports the hibernation and is not in a hibernation mode, and the node configuring hibernation time for the node according to a situation of a data uploading task, entering a hibernation state after the data uploading task is completed, and automatically waking up when the hibernation time is up.

The disclosure provides an energy-saving management system for a wireless sensor network, comprising: the wireless sensor network, a gateway device and a remote management server, wherein

the wireless sensor network is configured to send remaining energy information of a node, and/or network topology information, and/or node hibernation information to the remote management server through the gateway device and make a response according to a energy-saving decision of the remote management server; and

the remote management server is configured to store the remaining energy information of the node, and/or the network topology information, and/or the node hibernation information, make the energy-saving decision according to the remaining energy information of the node, and/or the network topology information, and/or the node hibernation information which are stored, and send the energy-saving decision to the wireless sensor network through the gateway device.

In the solution, the wireless sensor network sending the remaining energy information of the node to the remote management server through the gateway device is: the node of the wireless sensor network sending the remaining energy information of the node to the gateway device according to a set period, and the gateway device sending remaining energy information of all nodes to the remote management server after collecting the remaining energy information of all nodes; or, the gateway device actively initiating a data request to the wireless sensor network, and the wireless sensor network sending the remaining energy information of the node to the remote management server through the gateway device; or, the remote management server actively querying the wireless sensor network about the remaining energy information of the node, and the wireless sensor network making a response after receiving a query command.

In the solution, the wireless sensor network sending the remaining energy information of the node to the remote management server through the gateway device is: sending the remaining energy information of the node together with sensing data to the remote management server.

In the solution, the wireless sensor network sending the network topology information to the remote management server through the gateway device is: a new node establishing a routing to the gateway device when the new node is added to the wireless sensor network, and the gateway device sending information of the routing, which is newly established, to the remote management server after the routing is completely established; or, if a node is removed from the wireless sensor network, the gateway device sending information indicating that the node has been removed to the remote management server when finding in a next communication process that the node has been removed; or, when a node is moved, if the moved node has established a new routing to the gateway device before the gateway device finds that an original communication line is invalid, the gateway device sending information of the new routing to the remote management server, otherwise, performing a process for a case that the node is removed from the wireless sensor network.

The disclosure provides a remote management server, comprising: an information storage module and an energy-saving decision making module, wherein

the information storage module is configured to store remaining energy information of a node, network topology information and node hibernation information which are received; and

the energy-saving decision making module is configured to make an energy-saving decision according to the remaining energy information of the node, and/or the network topology information, and/or the node hibernation information which are stored, and send the energy-saving decision to the wireless sensor network through the gateway device.

In the solution, an information storage format of the information storage module comprises: a network identifier, a node identifier, information of a routing from the node to the gateway device, the remaining energy information of the node, and the node hibernation information, wherein the remaining energy information of the node comprises an absolute value of remaining energy and percentage of the remaining energy;

the energy-saving decision of the energy-saving decision making module comprises: control for network topology, and control for hibernation and wakeup of the node; and the energy-saving decision made by the energy-saving decision making module is specifically: in the control for the network topology, the remote management server determining a type of the wireless sensor network according to the network topology information that is stored, and replacing, according to an energy balance rule, a routing node or a cluster head node at regular intervals or each time when certain energy is consumed; and in the control for the hibernation and wakeup of the node, the remote management server judging whether the node supports hibernation according to the node hibernation information, and sending a hibernation configuration command to the node when the node supports the hibernation and is not in a hibernation mode, and the node configuring hibernation time for the node according to a situation of a data uploading task, entering a hibernation state after the data uploading task is completed, and automatically waking up when the hibernation time is up.

Through the solutions of the disclosure, the remote management server provides the wireless sensor network with an energy-saving strategy so as to reduce the processing amount of the wireless sensor network caused by network topology management, thereby reducing the power consumption, prolonging the lifetime, and implementing the remote energy-saving management of the wireless sensor network.

### BRIEF DESCRIPTION OF THE DRAWINGS

FIG. 1 is a diagram showing the composition structure of an energy-saving management system for a wireless sensor network in accordance with an embodiment of the disclosure;

FIG. 2 is a diagram showing the flow of an energy-saving management method for a wireless sensor network in accordance with an embodiment of the disclosure; and

FIG. 3 is a diagram showing the composition of an information storage format of a remote management server in accordance with an embodiment of the disclosure.

### DETAILED DESCRIPTION OF THE EMBODIMENTS

A basic principle of the disclosure is: a wireless sensor network sends remaining energy information of a node, and/or network topology information, and/or node hibernation information to a remote management server through a gateway device; and the remote management server stores the remaining energy information of the node, and/or the network topology information, and/or the node hibernation information, makes an energy-saving decision according to the stored information, and sends the energy-saving decision to the wireless sensor network through the gateway device.

In the wireless sensor network, the remote management server cannot complete all the energy-saving processing. However, for the energy-saving processing of a single node, the remote management server can control hibernation and wakeup of a node; and for the energy-saving processing of the whole wireless sensor network, the remote management server can manage and control the network topology.

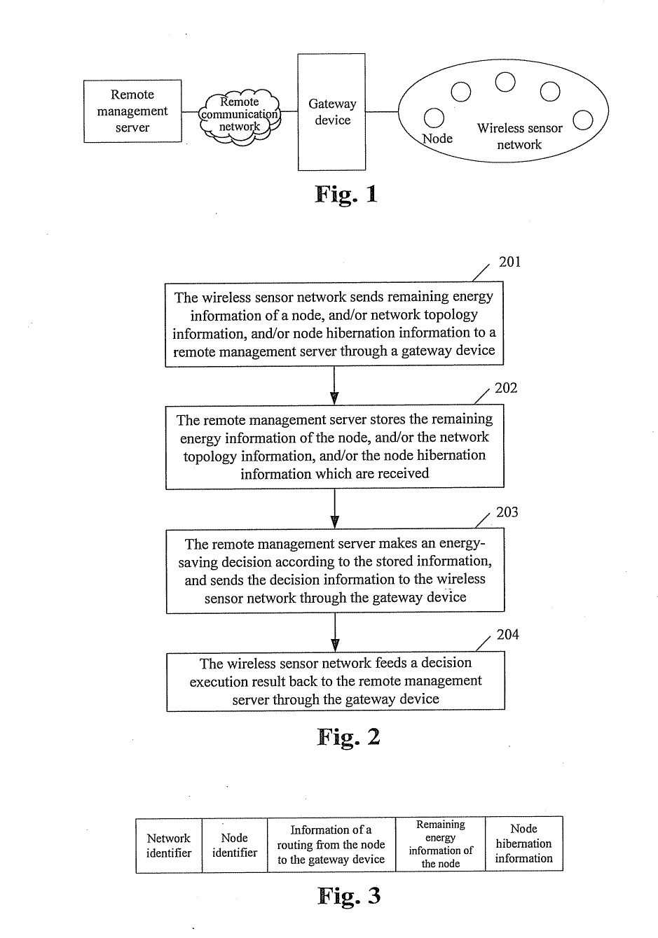

As shown in FIG. 1, an energy-saving management system for the wireless sensor network comprises a wireless sensor network, a gateway device and a remote management server, wherein the gateway device exchanges information with the remote management server through a remote communication network which supports one or more of the following ways: Second Generation (2G) mobile communication, 3G mobile communication, various x Digital Subscribe Lines (xDSLs), Fiber-to-the-x (FTTx), broadband wireless access, remote access of satellite/microwave and the like.

The solutions of the disclosure will be described below through embodiments in detail.

As shown in FIG. 2, an energy-saving management method for a wireless sensor network in accordance with an embodiment of the disclosure comprises steps as follows.

Step 201: The wireless sensor network sends remaining energy information of a node, and/or network topology information, and/or node hibernation information to a remote management server through a gateway device.

In the Step, the wireless sensor network may periodically send the remaining energy information of the node to the remote management server, specifically: a node of the wireless sensor network sends its own remaining energy information to the gateway device according to a set period, and the gateway device sends remaining energy information of all nodes to the remote management server after collecting the remaining energy information of all the nodes, wherein the period of sending the remaining energy information of the node may be determined by the remote management server or the gateway device.

The gateway device may actively initiate a data request to the wireless sensor network if not receiving the remaining energy information of the node in a specific period, and the wireless sensor network sends the remaining energy information of the node to the remote management server through the gateway device; or, the remote management server may actively query the wireless sensor network about the remaining energy information of the node through the gateway device, and the wireless sensor network makes a response after receiving a query command.

In order to save the power consumed for additionally sending the remaining energy information by the node, the remaining energy information of the node can be sent together with sensing data to the remote management server. The sensing data refer to the data which are periodically uploaded by the node in order to achieve a sensing task of the node. It is assumed that an uploading period of the remaining energy information of the node and an uploading period of the sensing data are respectively T1 and T2. If T1 is greater than T2, the node only needs to upload the remaining energy information once within T1, which is uploaded together with the sensing data. If T1 is less than T2, the node must additionally upload the remaining energy information of the node separately. It is unnecessary for the node to upload the remaining energy information very frequently; therefore, T1 should be generally greater than T2.

In addition, the wireless sensor network sends the network topology information to the remote management server when the network topology is changed. For example, a new node establishes a routing to the gateway device when the new node is added to the wireless sensor network, and then the gateway device sends information of the new established routing to the remote management server after the routing is completely established; or, if a node is removed from the wireless sensor network, the gateway device finds that the node has been removed in a next communication process and sends information indicating that the node has been removed to the remote management server; or, when a node is moved, if the gateway device finds that the moved node has established a new routing to the gateway device before an original communication line becomes invalid, the gateway device sends information of the new routing to the remote management server, otherwise, a process for a case that the node is removed from the wireless sensor network is performed, here, the gateway device can judge whether the communication line is normal according to the communication with the wireless sensor network, which is completely the same as that in the conventional art, thereby needing no further description.

When a network is established or a new node is added to the wireless sensor network, the new node sends the node hibernation information to the remote management server, wherein the node hibernation information comprises: whether the node supports a hibernation mode, and whether the node has been in the hibernation mode.

Step 202: The remote management server stores the remaining energy information of the node, and/or the network topology information, and/or the node hibernation information which are received.

In the step, as shown in FIG. 3, an information storage format of the remote management server comprises: a network identifier, a node identifier, information of a routing from the node to the gateway device, the remaining energy information of the node, and the node hibernation information. The network identifier is used for identifying different wireless sensor networks either by an Internet Protocol (IP) address identifier of the gateway device or by other identifiers, and nodes in the same wireless sensor network have the same network identifier. The node identifier is used for identifying a node in the wireless sensor network by an IP address or a Media Access Control (MAC) address of the node. The information of the routing from the node to the gateway device is used for recording a detailed path from the node to the gateway device. The remaining energy information of the node is used for recording current remaining energy of the node, and comprises an absolute value of the remaining energy and percentage of the remaining energy. The node hibernation information is used for indicating whether the node supports the hibernation mode and whether the node has been in the hibernation mode.

The process that the remote management server stores the remaining energy information of the node is: the remote management server updates and stores the remaining energy information of a corresponding node.

The process that the remote management server stores the network topology information comprises: for a newly-added node, the remote management server creates one piece of information for the node to store the information of the routing from the node to the gateway device; for a removed node, the remote management server deletes the information of the routing from the node to the gateway device; and for a moved node, the remote management server queries and modifies the information of the routing from the node to the gateway device.

Step 203: The remote management server makes an energy-saving decision according to the stored information, and sends the decision information to the wireless sensor network through the gateway device.

In the Step, the energy-saving decision mainly comprises: control for network topology, and control for hibernation and wakeup of the node, In the control for the network topology, a cluster head node or a routing node which is responsible for data forwarding is easy to become invalid as much energy will be consumed due to the data forwarding, and the remote management server determines a type of the wireless sensor network according to the stored network topology information, and replaces, according to an energy balance rule, the routing node or the cluster head node at regular intervals or each time when certain energy is consumed. The type of the wireless sensor network comprises: a structure based on a cluster, and a structure based on a routing node.

If the wireless sensor network is of the structure based on the cluster, the remote management server makes an energy-saving decision according to the remaining energy information of the cluster head node at regular intervals or whenever the upload of the remaining energy information of the wireless sensor network reaches specific times. If the remaining energy of the cluster head node is lower than a threshold or is significantly lower than that of some nodes in the cluster, the remote management server replaces the cluster head node with a node having the most remaining energy in the cluster, and sends the decision information to the wireless sensor network through the gateway device. After a new cluster head node receives the decision information from the remote management server, the new cluster head node executes cluster head functions and broadcasts a cluster head replacement message to other nodes in the cluster, which are then added to the new cluster and communicate with the new cluster head node, meanwhile, the original cluster head node becomes an ordinary node in the cluster.

If the wireless sensor network is of the structure based on the routing node which has a limited power supply capacity, for example, when a battery is used for power supply, the remote management server makes an energy-saving decision according to the remaining energy information of the routing node. If the remaining energy of the routing node is lower than a threshold or is significantly lower than that of some other sub nodes, the wireless sensor network replaces the routing node with a sub node having the most remaining energy and sends the decision information to the wireless sensor network through the gateway device. After a new routing node receives the decision information from the remote management server, the new routing node executes routing functions and broadcasts a routing replacement message to the sub nodes of the original routing node, each of which changes its own routing information and changes its own father node into the new routing node, meanwhile, the original routing node becomes an ordinary node.

In the control for the hibernation and wakeup of the node, the remote management server judges whether the node supports hibernation according to the node hibernation information, then judges whether the node has been in the hibernation mode if the node supports the hibernation, and sends a hibernation configuration command to the node if the node is not in the hibernation mode. After receiving the hibernation configuration command, the node configures hibernation time of the node according to a situation of a data uploading task of the node, such as: data uploading interval, enters a hibernation state after completing the period task of uploading data, i.e., the tasks in Step 201 to Step 204, and automatically wakes up when the hibernation time is up.

Step 204: The wireless sensor network feeds a decision execution result back to the remote management server through the gateway device.

In the Step, the wireless sensor network makes a response, i.e. implements energy-saving, according to the energy-saving decision of the remote management server, wherein the energy-saving specifically comprises: adjusting the network topology, entering hibernation, waking up and the like. After the execution of the energy-saving, the wireless sensor network feeds an execution result, i.e., whether the execution is successful or not, back to the remote management server through the gateway device.

In order to implement the method, an embodiment of the disclosure also provides an energy-saving management system for a wireless sensor network. The system comprises: a wireless sensor network, a gateway device and a remote management server, wherein

the wireless sensor network is configured to send remaining energy information of a node, and/or network topology information, and/or node hibernation information to the remote management server through the gateway device and make a response according to a energy-saving decision of the remote management server, specifically comprising: adjusting the network topology, entering hibernation, waking up etc.; and

the remote management server is configured to store the remaining energy information of the node, and/or the network topology information, and/or the node hibernation information, make the energy-saving decision according to the information above, and send the energy-saving decision to the wireless sensor network through the gateway device.

The process that the wireless sensor network sends the remaining energy information of the node to the remote management server through the gateway device is: the node of the wireless sensor network sends the remaining energy information of the node to the gateway device according to a set period, and the gateway device sends remaining energy information of all nodes to the remote management server after collecting the remaining energy information of all nodes; or, the gateway device actively initiates a data request to the wireless sensor network, and the wireless sensor network sends the remaining energy information of the node to the remote management server through the gateway device; or, the remote management server actively queries the wireless sensor network about the remaining energy information of the node, and the wireless sensor network makes a response after receiving a query command.

The process that the wireless sensor network sends the remaining energy information of the node to the remote management server through the gateway device is: the wireless sensor network sends the remaining energy information of the node together with sensing data to the remote management server.

The process that the wireless sensor network sends the network topology information to the remote management server through the gateway device is: a new node establishes a routing to the gateway device when the new node is added to the wireless sensor network, and the gateway device sends information of the routing, which is newly established, to the remote management server after the routing is completely established; or, if a node is removed from the wireless sensor network, the gateway device sends information indicating that the node has been removed to the remote management server when finding in a next communication process that the node has been removed; or, when a node is moved, if the moved node has established a new routing to the gateway device before the gateway device finds that an original communication line is invalid, the gateway device sends information of the new routing to the remote management server, otherwise, performs a process for a case that the node is removed from the wireless sensor network.

An embodiment of the disclosure also provides a remote management server, which comprises: an information storing module and an energy-saving decision making module, wherein

the information storage module is configured to store remaining energy information of a node, network topology information and node hibernation information which are received; and

the energy-saving decision making module is configured to make an energy-saving decision according to the remaining energy information of the node, and/or the network topology information, and/or the node hibernation information which are stored, and send the energy-saving decision to the wireless sensor network through the gateway device.

An information storage format of the information storage module comprises: a network identifier, a node identifier, information of a routing from the node to the gateway device, the remaining energy information of the node, and the node hibernation information, wherein the network identifier is used for identifying different wireless sensor networks either by an IP address identifier of the gateway device or by other identifiers;

the node identifier is used for identifying the node in the wireless sensor network by an IP address or MAC address identifier of the node;

the information of the routing from the node to the gateway device is used for recording a detailed path from the node to the gateway device;

the remaining energy information of the node is used for recording current remaining energy of the node, and comprises an absolute value of the remaining energy and percentage of the remaining energy; and

the node hibernation information is used for indicating whether the node supports the hibernation mode and whether the node has been in the hibernation mode.

The energy-saving decision of the energy-saving decision making module comprises: control for network topology, and control for hibernation and wakeup of the node; and the energy-saving decision made by the energy-saving decision making module is specifically: in the control for the network topology, the remote management server determines a type of the wireless sensor network according to the network topology information that is stored, and replaces, according to an energy balance rule, a routing node or a cluster head node at regular intervals or each time when certain energy is consumed; and in the control for the hibernation and wakeup of the node, the remote management server judges whether the node supports hibernation according to the node hibernation information, and sends a hibernation configuration command to the node when the node supports the hibernation and is not in a hibernation mode, and the node configures hibernation time for the node according to a situation of a data uploading task, enters a hibernation state after the data uploading task is completed, and automatically wakes up when the hibernation time is up.

What described above are only preferred embodiments of the disclosure, and not used for limiting the protection scope of the disclosure; and any modifications, equivalent replacements, improvements and the like within the spirit and principle of the disclosure shall fall within the protection scope of the disclosure.

1. An energy-saving management method for a wireless sensor network, comprising:
the wireless sensor network sending remaining energy information of a node, and/or network topology information, and/or node hibernation information to a remote management server through a gateway device;
the remote management server storing the remaining energy information of the node, and/or the network topology information, and/or the node hibernation information, making an energy-saving decision according to the remaining energy information of the node, and/or the network topology information, and/or the node hibernation information which are stored, and sending the energy-saving decision to the wireless sensor network through the gateway device; and
the wireless sensor network making a response according to the energy-saving decision of the remote management server.

2. The method according to claim 1, wherein the wireless sensor network sending the remaining energy information of the node to the remote management server through the gateway device is:
the node of the wireless sensor network sending the remaining energy information of the node to the gateway device according to a set period, and the gateway device sending remaining energy information of all nodes to the remote management server after collecting the remaining energy information of all nodes; or,
the gateway device actively initiating a data request to the wireless sensor network, and the wireless sensor network sending the remaining energy information of the node to the remote management server through the gateway device; or,
the remote management server actively querying the wireless sensor network about the remaining energy information of the node, and the wireless sensor network making a response after receiving a query command.

3. The method according to claim 1, wherein the wireless sensor network sending the remaining energy information of the node to the remote management server through the gateway device is: sending the remaining energy information of the node together with sensing data to the remote management server.

4. The method according to claim 1, wherein the wireless sensor network sending the network topology information to the remote management server through the gateway device is:
a new node establishing a routing to the gateway device when the new node is added to the wireless sensor network, and the gateway device sending information of the routing, which is newly established, to the remote management server after the routing is completely established; or,
if a node is removed from the wireless sensor network, the gateway device sending information indicating that the node has been removed to the remote management server when finding, in a next communication process, that the node has been removed; or,
when a node is moved, if the moved node has established a new routing to the gateway device before the gateway device finds that an original communication line is invalid, the gateway device sending information of the new routing to the remote management server, otherwise, performing a process for a case that the node is removed from the wireless sensor network.

5. The method according to claim 1, wherein an information storage format of the remote management server comprises: a network identifier, a node identifier, information of a routing from the node to the gateway device, the remaining energy information of the node, and the node hibernation information, wherein the remaining energy information of the node comprises an absolute value of remaining energy and percentage of the remaining energy.

6. The method according to claim 1, wherein the energy-saving decision of the remote management server comprises: control for network topology, and control for hibernation and wakeup of the node, specifically:
in the control for the network topology, the remote management server determining a type of the wireless sensor network according to the network topology information that is stored, and replacing, according to an energy balance rule, a routing node or a cluster head node at regular intervals or each time when certain energy is consumed; and
in the control for the hibernation and wakeup of the node, the remote management server judging whether the node supports hibernation according to the node hibernation information, and sending a hibernation configuration command to the node when the node supports the hibernation and is not in a hibernation mode, and the node configuring hibernation time for the node according to a situation of a data uploading task, entering a hibernation state after the data uploading task is completed, and automatically waking up when the hibernation time is up.

7. An energy-saving management system for a wireless sensor network, comprising: the wireless sensor network, a gateway device and a remote management server, wherein
the wireless sensor network is configured to send remaining energy information of a node, and/or network topology information, and/or node hibernation information to the remote management server through the gateway device and make a response according to a energy-saving decision of the remote management server; and
the remote management server is configured to store the remaining energy information of the node, and/or the network topology information, and/or the node hibernation information, make the energy-saving decision according to the remaining energy information of the node, and/or the network topology information, and/or the node hibernation information which are stored, and send the energy-saving decision to the wireless sensor network through the gateway device.

8. The system according to claim 7, wherein the wireless sensor network sending the remaining energy information of the node to the remote management server through the gateway device is:
the node of the wireless sensor network sending the remaining energy information of the node to the gateway device according to a set period, and the gateway device sending remaining energy information of all nodes to the remote management server after collecting the remaining energy information of all nodes; or,
the gateway device actively initiating a data request to the wireless sensor network, and the wireless sensor network sending the remaining energy information of the node to the remote management server through the gateway device; or,
the remote management server actively querying the wireless sensor network about the remaining energy information of the node, and the wireless sensor network making a response after receiving a query command.

9. The system according to claim 7, wherein the wireless sensor network sending the remaining energy information of the node to the remote management server through the gateway device is: sending the remaining energy information of the node together with sensing data to the remote management server.

10. The system according to claim 7, wherein the wireless sensor network sending the network topology information to the remote management server through the gateway device is:
a new node establishing a routing to the gateway device when the new node is added to the wireless sensor network, and the gateway device sending information of the routing, which is newly established, to the remote management server after the routing is completely established; or,
if a node is removed from the wireless sensor network, the gateway device sending information indicating that the node has been removed to the remote management server when finding in a next communication process that the node has been removed; or,
when a node is moved, if the moved node has established a new routing to the gateway device before the gateway device finds that an original communication line is invalid, the gateway device sending information of the new routing to the remote management server, otherwise, performing a process for a case that the node is removed from the wireless sensor network.

11. A remote management server, comprising: an information storage module and an energy-saving decision making module, wherein
the information storage module is configured to store remaining energy information of a node, network topology information and node hibernation information which are received; and
the energy-saving decision making module is configured to make an energy-saving decision according to the remaining energy information of the node, and/or the network topology information, and/or the node hibernation information which are stored, and send the energy-saving decision to the wireless sensor network through the gateway device.

12. The remote management server according to claim 11, wherein
an information storage format of the information storage module comprises: a network identifier, a node identifier, information of a routing from the node to the gateway device, the remaining energy information of the node, and the node hibernation information, wherein the remaining energy information of the node comprises an absolute value of remaining energy and percentage of the remaining energy;
the energy-saving decision of the energy-saving decision making module comprises: control for network topology, and control for hibernation and wakeup of the node; and the energy-saving decision made by the energy-saving decision making module is specifically:
in the control for the network topology, the remote management server determining a type of the wireless sensor network according to the network topology information that is stored, and replacing, according to an energy balance rule, a routing node or a cluster head node at regular intervals or each time when certain energy is consumed; and
in the control for the hibernation and wakeup of the node, the remote management server judging whether the node supports hibernation according to the node hibernation information, and sending a hibernation configuration command to the node when the node supports the hibernation and is not in a hibernation mode, and the node configuring hibernation time for the node according to a situation of a data uploading task, entering a hibernation state after the data uploading task is completed, and automatically waking up when the hibernation time is up.

13. The method according to claim 2, wherein the energy-saving decision of the remote management server comprises: control for network topology, and control for hibernation and wakeup of the node, specifically:
in the control for the network topology, the remote management server determining a type of the wireless sensor network according to the network topology information that is stored, and replacing, according to an energy balance rule, a routing node or a cluster head node at regular intervals or each time when certain energy is consumed; and
in the control for the hibernation and wakeup of the node, the remote management server judging whether the node supports hibernation according to the node hibernation information, and sending a hibernation configuration command to the node when the node supports the hibernation and is not in a hibernation mode, and the node configuring hibernation time for the node according to a situation of a data uploading task, entering a hibernation state after the data uploading task is completed, and automatically waking up when the hibernation time is up.

14. The method according to claim 3, wherein the energy-saving decision of the remote management server comprises: control for network topology, and control for hibernation and wakeup of the node, specifically:
in the control for the network topology, the remote management server determining a type of the wireless sensor network according to the network topology information that is stored, and replacing, according to an energy balance rule, a routing node or a cluster head node at regular intervals or each time when certain energy is consumed; and
in the control for the hibernation and wakeup of the node, the remote management server judging whether the node supports hibernation according to the node hibernation information, and sending a hibernation configuration command to the node when the node supports the hibernation and is not in a hibernation mode, and the node configuring hibernation time for the node according to a situation of a data uploading task, entering a hibernation state after the data uploading task is completed, and automatically waking up when the hibernation time is up.

15. The method according to claim 4, wherein the energy-saving decision of the remote management server comprises: control for network topology, and control for hibernation and wakeup of the node, specifically:
in the control for the network topology, the remote management server determining a type of the wireless sensor network according to the network topology information that is stored, and replacing, according to an energy balance rule, a routing node or a cluster head node at regular intervals or each time when certain energy is consumed; and
in the control for the hibernation and wakeup of the node, the remote management server judging whether the node supports hibernation according to the node hibernation information, and sending a hibernation configuration command to the node when the node supports the hibernation and is not in a hibernation mode, and the node configuring hibernation time for the node according to a situation of a data uploading task, entering a hibernation state after the data uploading task is completed, and automatically waking up when the hibernation time is up.

16. The method according to claim 5, wherein the energy-saving decision of the remote management server comprises: control for network topology, and control for hibernation and wakeup of the node, specifically:
in the control for the network topology, the remote management server determining a type of the wireless sensor network according to the network topology information that is stored, and replacing, according to an energy balance rule, a routing node or a cluster head node at regular intervals or each time when certain energy is consumed; and
in the control for the hibernation and wakeup of the node, the remote management server judging whether the node supports hibernation according to the node hibernation information, and sending a hibernation configuration command to the node when the node supports the hibernation and is not in a hibernation mode, and the node configuring hibernation time for the node according to a situation of a data uploading task, entering a hibernation state after the data uploading task is completed, and automatically waking up when the hibernation time is up.

17. The system according to claim 8, wherein the wireless sensor network sending the network topology information to the remote management server through the gateway device is:
a new node establishing a routing to the gateway device when the new node is added to the wireless sensor network, and the gateway device sending information of the routing, which is newly established, to the remote management server after the routing is completely established; or,
if a node is removed from the wireless sensor network, the gateway device sending information indicating that the node has been removed to the remote management server when finding in a next communication process that the node has been removed; or,
when a node is moved, if the moved node has established a new routing to the gateway device before the gateway device finds that an original communication line is invalid, the gateway device sending information of the new routing to the remote management server, otherwise, performing a process for a case that the node is removed from the wireless sensor network.

18. The system according to claim 9, wherein the wireless sensor network sending the network topology information to the remote management server through the gateway device is:
a new node establishing a routing to the gateway device when the new node is added to the wireless sensor network, and the gateway device sending information of the routing, which is newly established, to the remote management server after the routing is completely established; or,
if a node is removed from the wireless sensor network, the gateway device sending information indicating that the node has been removed to the remote management server when finding in a next communication process that the node has been removed; or,
when a node is moved, if the moved node has established a new routing to the gateway device before the gateway device finds that an original communication line is invalid, the gateway device sending information of the new routing to the remote management server, otherwise, performing a process for a case that the node is removed from the wireless sensor network.
